(19) United States
(12) Patent Application Publication
(10) Pub. No.: US 2021/0098816 A1
(43) Pub. Date: Apr. 1, 2021

(54) BATTERY STACK AND METHOD OF MANUFACTURING THE SAME

(71) Applicant: Toyota Jidosha Kabushiki Kaisha, Toyota-shi (JP)

(72) Inventor: Masao OHMURA, Toyota-shi (JP)

(73) Assignee: Toyota Jidosha Kabushiki Kaisha, Toyota-shi (JP)

(21) Appl. No.: 17/025,996

(22) Filed: Sep. 18, 2020

(30) Foreign Application Priority Data
Sep. 27, 2019 (JP) 2019-177473

(51) Int. Cl. H01M 10/04; H01M 10/48; H01M 2/10; H01M 10/615; H01M 10/63; H01M 10/625; H01M 2/14

(52) U.S. Cl. CPC H01M 10/0468; H01M 10/486; H01M 2/1077; H01M 2220/20; H01M 10/63; H01M 10/625; H01M 2/14; H01M 10/615

(57) ABSTRACT

A battery stack includes: plural substantially rectangular body-shaped battery cells; a pair of end plates disposed at respective end parts, in a stacking direction, of the plural battery cells, which are stacked in a short direction of the battery cells; a restraint band configured to restrain the pair of end plates, and to apply a stacking direction load to the battery cells, which are stacked between the end plates; and a load change suppression member configured to suppress change in the stacking direction load acting on the battery cells by pressing the end plates in a case in which an ambient temperature of the battery cells or a cell temperature of the battery cells has changed.

### CROSS-REFERENCE TO RELATED APPLICATION

This application claims priority under 35 USC 119 from Japanese Patent Application No. 2019-177473 filed on Sep. 27, 2019, the disclosure of which is incorporated by reference herein in its entirety.

### BACKGROUND

### Technical Field

The present disclosure relates to a battery stack and a method for manufacturing the same.

### Related Art

Conventionally, a battery stack is formed by stacking plural substantially rectangular battery cells, arranging a pair of end plates at respective ends in the stacking direction, and fixing the pair of end plates with a predetermined load applied between the end plates, as described in, for example, Japanese Patent Application Laid-Open No. 2010-099989.

If a predetermined load is not applied to the stacked battery cells in this manner, the battery cells may become defective due to vibration when mounted on a vehicle or the like.

### SUMMARY

On the other hand, the battery cell expands and contracts depending on the usage state of the battery stack, for example, the temperature, the charge amount, changes over time, and the like, of the battery cell. When the battery cell expands, an excessive load acts on the battery cell, and the battery cell may become defective.

Further, when the battery cell contracts, the load acting on the battery is insufficient, and the battery cell may become defective due to vibration when the battery stack is mounted on a vehicle.

In view of the above, the present disclosure provides a battery stack that suppresses a change in the load acting on a battery cell, and a method for manufacturing the same.

A battery stack of a first aspect includes: plural substantially rectangular body-shaped battery cells; a pair of end plates disposed at respective end parts, in a stacking direction, of the plural battery cells, which are stacked in a short direction of the battery cells; a restraint band configured to restrain the pair of end plates, and to apply a stacking direction load to the battery cells, which are stacked between the end plates; and a load change suppression member configured to suppress change in the stacking direction load acting on the battery cells by pressing the end plates in a case in which an ambient temperature of the battery cells or a cell temperature of the battery cells has changed.

In this battery stack, a plurality of battery cells each having a rectangular shape are stacked in the short direction, and a pair of end plates disposed at respective ends in the stacking direction of the stacked battery cells are restrained by a restraint band, whereby a stacking direction load acts on each of the stacked battery cells.

Incidentally, when the ambient temperature of the battery cell or the temperature of the battery cell rises, each battery cell configuring the battery stack expands. At this time, since the pair of end plates is restrained by the restraint band, the stacking direction load acting on each battery cell arranged between the end plates increases. If the stacking direction load exceeds a predetermined value, the battery cells may become defective.

Further, when each battery cell configuring the battery stack shrinks due to a decrease in the ambient temperature of the battery cell or the temperature of the battery cell, the stacking direction load acting on each battery cell decreases. If the load in the stacking direction is less than a predetermined value, the battery cells may become defective due to, for example, vibration of a vehicle equipped with the battery stack.

However, since the battery stack is provided with the load change suppression member, the load change suppression member presses the end plates when the ambient temperature of the battery cell or the temperature of the battery cell changes, whereby a change in the stacking direction load acting on the battery cells can be suppressed.

A battery stack according to a second aspect is the battery stack according to the first aspect, in which the load change suppression member includes a spacer that is disposed between the pair of end plates such that respective end parts of the spacer abut on the respective end plates, and that has a larger coefficient of linear expansion than the restraint band.

In this battery stack, a spacer is provided between the pair of end plates so that respective end parts of the spacer abut on the respective end plates. Since this spacer has a larger linear expansion coefficient than the restraint band, the spacer expands more than the restraint band when the ambient temperature of the battery cell or the temperature of the battery cell rises. Therefore, the distance between the end plates restrained by the restraint band is increased. That is, it is possible to prevent or suppress an increase in the load in the stacking direction acting on each battery cell arranged between the pair of end plates in the battery stack when the ambient temperature of the battery cell or the temperature of the battery cell rises.

A battery stack according to a third aspect is the battery stack according to the first aspect, in which the load change suppression member includes: a spacer that is disposed between the pair of end plates such that respective end parts of the spacer abut on the respective end plates; and a heater configured to heat the spacer.

In this battery stack, a spacer that is disposed between the pair of end plates so that respective end parts of the spacer abut on the respective end plates, and a heater that heats the spacer, are provided.

Therefore, when the ambient temperature of the battery cell or the temperature of the battery cell rises, the spacer is expanded by heating the spacer with the heater, and the distance between the end plates restrained by the restraint band can be increased. That is, it is possible to prevent or suppress an increase in the load in the stacking direction acting on each battery cell arranged between the end plates in the battery stack when the ambient temperature of the battery cell or the temperature of the battery cell rises.

A battery stack according to a fourth aspect is the battery stack according to the third aspect, further including: a temperature detection unit configured to detect the cell temperature of the battery cells or the ambient temperature of the battery cells; and a heater control unit configured to drive the heater in a case in which the cell temperature or the ambient temperature detected by the temperature detection unit is equal to or higher than a predetermined temperature.

In this battery stack, the heater control unit drives the heater when the ambient temperature of the battery cell or the temperature of the battery cell detected by the temperature detection unit is equal to or higher than a predetermined temperature. Thereby, even when the battery cells of the battery stack expand due to an increase in the ambient temperature of the battery cell or the temperature of the battery cell, the end plates located at respective ends of the spacer are pressed by the expansion of the spacer heated by the heater, increasing the distance between the end plates. As a result, it is possible to prevent or suppress an increase in the load in the stacking direction acting on the stacked battery cells of the battery stack due to temperature rise.

A battery stack according to a fifth aspect is the battery stack according to the first aspect, in which the load change suppression member includes: a spacer that is disposed between one of the end plates and one wall part such that respective end parts of the spacer abut on the one of the end plates and the one wall part; and a heater configured to heat the spacer, in which another of the end plates abuts on another wall part.

In this battery stack, a plurality of battery cells each having a rectangular shape are stacked in the short direction, and a pair of end plates disposed at respective ends of the stacked battery cells are restrained by a restraint band, whereby a stacking direction load acts on each of the stacked battery cells.

When each battery cell configuring the battery stack shrinks due to a decrease in the ambient temperature of the battery cell or the temperature of the battery cell, the stacking direction load acting on each battery cell decreases. If the load in the stacking direction is less than a predetermined value, the battery cells may become defective due to, for example, vibration of a vehicle equipped with the battery stack.

In this battery stack, a spacer, having respective ends that abut on one end plate and one wall part, is inserted between the one end plate and the one wall part. This spacer is heatable by a heater. The other end plate is in contact with another wall part.

Therefore, when the ambient temperature of the battery cell or the temperature of the battery cell decreases, the spacer can be expanded by heating by the heater. At this time, since the spacer is in contact with one of the wall parts, the spacer presses one of the end plates by expansion, thereby reducing the distance from the other of the end plates in contact with the other wall part. As a result, a decrease in the load in the stacking direction acting on the battery cells stacked between the end plates in the battery stack is prevented or suppressed.

A battery stack according to a sixth aspect is the battery stack according to the fifth aspect, further including: a temperature detection unit configured to detect the cell temperature of the battery cells or the ambient temperature of the battery cells; and a heater control unit configured to drive the heater in a case in which the cell temperature or the ambient temperature detected by the temperature detection unit is equal to or lower than a predetermined temperature.

In this battery stack, the heater control unit drives the heater when the ambient temperature of the battery cell or the temperature of the battery cell detected by the temperature detection unit is equal to or lower than a predetermined temperature. Thereby, even if the battery cells of the battery stack shrink due to a decrease in the ambient temperature of the battery cell or the temperature of the battery cell, the spacer heated by the heater expands to press one of the end plates, thereby shortening the distance to the other end plate. As a result, it is possible to prevent or suppress a decrease in the load in the stacking direction acting on the stacked battery cells of the battery stack due to temperature decrease.

A battery stack according to a seventh aspect is the battery stack according to the fifth aspect, in which the one wall part includes an adjustment unit including a screw hole that is open toward the one of the end plates, and a threading amount of a screw threaded into the screw hole is adjustable.

In this battery stack, the load in the stacking direction acting on each battery cell due to the restraining of the pair of end plates by the restraint band, is reduced by creep of the restraint band or the like. At this time, it is possible to effect an adjustment such that the distance between the end plates is reduced by screwing the screw threaded into the screw hole of the adjustment unit toward the end plate side by inserting the screw and pushing the spacer with the screw. Accordingly, it is possible to prevent or suppress a decrease in the load in the stacking direction acting on the battery cells of the battery stack due to creep caused by aging.

A method of manufacturing a battery stack according to an eighth aspect includes: applying a predetermined stacking direction load to respective battery cells by attaching a pair of end plates to respective end parts, in a stacking direction, of a stacked plurality of the battery cells, and by restraining the pair of end plates with a restraint band in a state in which the predetermined stacking direction load is applied between the pair of end plates; and press-fitting a spacer between the pair of end plates such that respective end parts of the spacer abut on the respective end plates.

In this method of manufacturing a battery stack, first, a predetermined load in the stacking direction is applied between a pair of end plates in a state in which the pair of end plates are disposed at respective ends in the stacking direction of plural stacked battery cells.

By restraining the pair of end plates with the restraint band in this state, a predetermined load in the stacking direction acts on each of the stacked battery cells. Further, by press-fitting the spacer between the pair of end plates restrained by the restraint band, respective ends of the spacer abut on the respective end plates.

In this manner, a battery stack, in which a spacer is disposed between a pair of end plates while a predetermined load in the stacking direction is applied to stacked battery cells, can be easily configured.

A method of manufacturing a battery stack according to a ninth aspect includes: attaching end plates to respective end parts, in a stacking direction, of plural stacked battery cells, and disposing a spacer between a pair of the end plates such that respective end parts of the spacer abut on the respective end plates; and restraining the pair of end plates with a restraint band in a state in which a predetermined stacking direction load is applied to each of the battery cells stacked between the pair of end plates.

In this method of manufacturing a battery stack, a pair of end plates are provided at respective ends in the stacking direction of plural stacked battery cells, and a spacer is arranged between the pair of end plates.

Next, a predetermined load in the stacking direction is applied to each battery cell disposed between the pair of end plates, and in this state, the pair of end plates are restrained by a restraint band. As a result, a state in which a predetermined load in the stacking direction is applied to each of the stacked battery cells is maintained.

In this manner, a battery stack, in which a spacer is disposed between a pair of end plates while a predetermined load in the stacking direction is applied to stacked battery cells, can be easily configured.

A method of manufacturing a battery stack according to a tenth aspect includes: manufacturing a battery stack main body in which a predetermined stacking direction load is applied to respective battery cells, by disposing a pair of end plates at respective end parts, in a stacking direction, of a stacked plurality of the battery cells, and by restraining the pair of end plates with a restraint band in a state in which the predetermined stacking direction load is applied between the pair of end plates by a restraining jig; releasing the predetermined stacking direction load that was being applied between the pair of end plates by the restraining jig; disposing the battery stack main body inside a housing such that one of the end plates abuts on one wall part of the housing; and in a case in which a distance between the pair of end plates exceeds a predetermined distance, inserting a spacer so as to abut on another of the end plates and another wall part of the housing in a state in which the distance between the pair of end plates has been adjusted by reduction by pressing the other of the end plates with a re-restraining jig.

In this method of manufacturing a battery stack, a pair of end plates disposed at respective ends in the stacking direction of plural stacked battery cells are restrained by a restraint band in a state in which a predetermined stacking direction load is applied between the pair of end plates by a restraining jig. Then, the action of the load in the stacking direction by the restraining jig is released.

Thereby, a battery stack main body, in which a predetermined load in the stacking direction is applied between the pair of end plates by the restraint band, is manufactured.

Next, in a state in which one end plate of the battery stack main body abuts on one wall part of a housing, when the distance between the end plates is equal to or more than a predetermined distance, the other end plate is pressed by a jig, the distance between the end plates is reduced and adjusted, and in this state, a spacer is inserted between another wall part of the housing and the other end plate.

In this method of manufacturing a battery stack, by restraining a pair of end plates with a restraint band at the time of manufacturing a battery stack main body, and then adjusting the distance between the end plates once more when installing the battery stack main body inside a housing, the accuracy of the load in the stacking direction acting on the battery cells can be improved.

As described above, according to the battery stacks of the first to seventh aspects, it is possible to suppress a change in the load in the stacking direction acting on the battery cells configuring the battery stack.

According to the battery stack manufacturing methods of the eighth and ninth aspects, the battery stack can be easily manufactured.

Furthermore, according to the battery stack manufacturing method of the tenth aspect, the accuracy of the load in the stacking direction acting on the battery cells can be improved.

### BRIEF DESCRIPTION OF THE DRAWINGS

Exemplary embodiments of the present invention will be described in detail based on the following figures, wherein:

FIG. 1A is a plan view of a battery stack according to the first embodiment;

FIG. 1B is a front view of the battery stack according to the first embodiment;

FIG. 2 is a schematic configuration diagram of a battery stack according to a second embodiment;

FIG. 3 is an explanatory view of a pressurized state at the time of manufacturing the battery stack according to the third embodiment;

FIG. 4 is a plan view of a battery stack main body according to the third embodiment;

FIG. 5 is a schematic configuration diagram of a battery stack according to a third embodiment;

FIG. 6 is a plan view showing, in partial cross section, a main part of a battery stack according to a fourth embodiment;

FIG. 7 is a schematic configuration diagram of a battery stack according to a fourth embodiment;

FIG. 8 is an explanatory view of a pressurized state at the time of manufacturing the battery stack according to another example 1 of the third embodiment;

FIG. 9 is an explanatory view of a state after release of pressurization at the time of manufacturing the battery stack according to another example 1 of the fourth embodiment;

FIG. 10A is a plan view showing a partial cross section for explaining a re-pressurized state at the time of manufacturing a battery stack according to another example 1 of the fourth embodiment;

FIG. 10B is a sectional view taken along line A-A of FIG. 10A;

FIG. 11A is a plan view showing, in partial cross section, a battery stack according to another example 1 of the fourth embodiment;

FIG. 11B is a sectional view taken along line B-B of FIG. 11A; and

FIG. 12 is a front view of the battery stack according to another example 2 of the fourth embodiment.

### DETAILED DESCRIPTION

### First Exemplary Embodiment

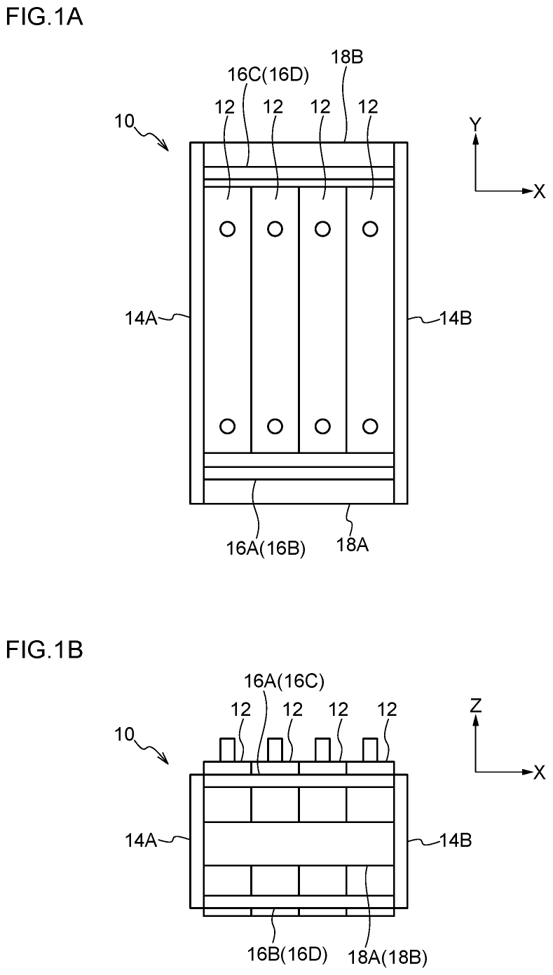

The battery stack according to the first embodiment will be described with reference to FIGS. 1A and 1B. In the following drawings, the short direction of the battery cell is indicated by an arrow X direction, the long direction is indicated by an arrow Y direction, and the height direction is indicated by an arrow Z direction. The same applies to the following embodiments.

(Configuration) The overall configuration of the battery stack 10 will be described.

As shown in FIGS. 1A and 1B, the battery stack 10 includes a plurality of battery cells 12, a pair of end plates 14A and 14B, four restraint bands 16A to 16D, and two spacers 18A and 18B.

The spacers 18A and 18B correspond to a “load change suppression member.”

The battery cells 12 are formed in a substantially rectangular shape, and a plurality of the battery cells 12 are stacked along the short direction of the battery cells 12. Hereinafter, the short direction of the battery cell 12 is referred to as the “short direction.”

The pair of end plates 14A and 14B are arranged outside the outermost-placed battery cells 12 of the plurality of stacked battery cells 12, at the side at which battery cells are not stacked in the battery cells disposed outermost in the stacking direction.

As shown in FIGS. 1A and 1B, the restraint bands 16A to 16D respectively extend in the stacking direction of the battery cells 12, that is, in the short direction of the battery cells 12, and are disposed with two on each side in the longitudinal direction of the stacked battery cells 12 between the pair of end plates 14A and 14B. Hereinafter, the longitudinal direction of the stacked battery cells 12 is referred to as the “longitudinal direction.”

In addition, both ends of the restraint bands 16A to 16D are connected to the pair of end plates 14A and 14B. The connection can be performed, for example, by fixing or fastening. The restraint bands 16A to 16D hold the end plates 14A and 14B to keep the distance between the end plates 14A and 14B constant, and apply a predetermined load in the stacking direction to each battery cell 12 stacked between the end plates 14A and 14B. Hereinafter, the distance between the end plates 14A and 14B is referred to as the “end plate distance.” The load in the stacking direction is referred to as the “load.”

The spacers 18A and 18B respectively extend in the short direction on both sides in the longitudinal direction of the battery cells 12, and are disposed between the pair of end plates 14A and 14B. As shown in FIG. 1B, the spacers 18A and 18B are disposed in parallel with the restraint bands 16A, 16C, 16B and 16D at side parts in the longitudinal direction of the stacked battery cells 12. The spacers 18A and 18B have the same length in the short direction as the restraint bands 16A to 16D.

In addition, both ends of the spacers 18A and 18B are in contact with the end plates 14A and 14B. “Contact” includes fixing, fastening, insertion, press fitting, and the like. Hereinafter, the same applies in the case of “contact.” In the present embodiment, it is assumed that the spacers 18A and 18B are press-fitted between the end plates 14A and 14B.

The spacers 18A and 18B have a larger coefficient of linear expansion than the restraint bands 16A to 16D.

### (Action)

Next, the operation of the battery stack 10 of the present embodiment will be described.

In the battery stack 10, each battery cell 12 expands due to a rise in the ambient temperature or the temperature of the battery cell 12, or a change in the amount of charge. As a result, the load acting on the battery cell 12 due to the restraint band 16 restraining the end plates 14A and 14B increases. Here, when the load acting on each battery cell 12 exceeds a predetermined load, the quality of the battery cell 12 becomes poor.

In the battery stack 10, spacers 18A and 18B having a larger linear expansion coefficient than the restraint bands 16A to 16D are pressed into the end plates 14A and 14B in parallel with the restraint bands 16A to 16D. Therefore, the spacers 18A and 18B extend further than the restraint bands 16A to 16D due to an increase in the ambient temperature or the temperature of the battery cell 12, and increase the distance between the end plates. As a result, an increase in the load acting on the battery cell 12 due to an increase in the ambient temperature or the temperature of the battery cell 12 can be prevented or suppressed. Thereby, the increase in the load acting on the battery cell 12 at the time of high temperature can be suppressed, and the battery cell 12 can be prevented or suppressed from becoming defective.

### Second Exemplary Embodiment

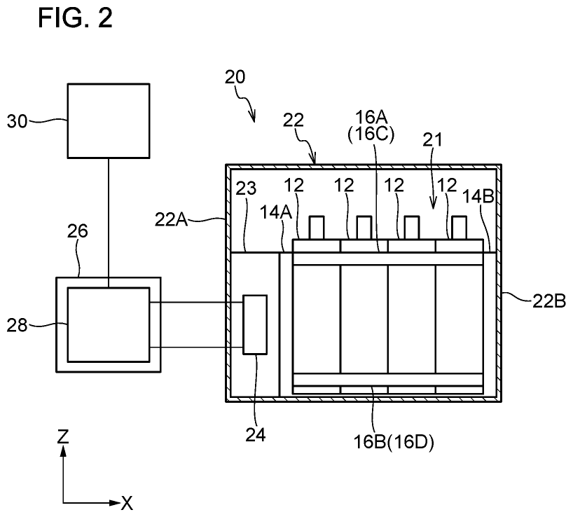

The battery stack according to the second embodiment will be described with reference to FIG. 2. Configuration elements that are similar to those in the battery stack of the first exemplary embodiment are appended with the same reference numerals, and detailed explanation thereof is omitted.

### (Configuration)

As shown in FIG. 2, the battery stack 20 includes a battery stack main body 21, a housing 22, a spacer 23, a heater 24, a control unit 26, and a temperature sensor 30.

The spacer 23 and the heater 24 correspond to a “load change suppressing member.”

In the battery stack main body 21, the battery cells 12 are stacked between the end plates 14A and 14B in substantially the same manner as the battery stack 10 of the first embodiment. Owing to the end plates 14A and 14B being restrained by the restraint bands 16A to 16D, a predetermined load acts on the battery cells 12 arranged between the end plates 14A and 14B. In other words, the battery stack main body 21 has a configuration in which the spacers 18A and 18B are removed from the battery stack 10 of the first embodiment.

The housing 22 houses the battery stack main body 21 and the spacer 23 inside. The housing 22 has vertical walls 22A and 22B arranged to face each other. The battery stack main body 21 is disposed inside the housing 22 with one end plate 14B abutting against one vertical wall 22B. The vertical walls 22A and 22B each correspond to a “wall.”

Further, a spacer 23 is provided between the vertical wall 22A and the other end plate 14A. Respective ends of the spacer 23 are in contact with the vertical wall 22A of the housing 22 and the other end plate 14A. The spacer 23 is provided with a heater 24.

A temperature sensor 30 is provided outside the housing 22 to detect an ambient temperature of the battery cell 12.

The control unit 26 is provided with a heater control circuit 28. The heater control circuit 28 energizes the heater 24 when the ambient temperature is equal to or lower than a predetermined temperature based on a detection signal of the temperature sensor 30. Note that the heater control circuit 28 corresponds to a “heater control unit.” The temperature sensor 30 corresponds to a “temperature detecting unit.”

### (Action)

Next, the operation of the battery stack 20 of the present embodiment will be described.

In the battery stack 20, each battery cell 12 is reduced in size by a decrease in the ambient temperature. Thereby, the load applied to the battery cell 12 by the restraint band 16 via the end plates 14A and 14B is reduced. Here, if the load acting on each battery cell 12 falls below a predetermined load, the quality of the battery cell 12 may be impaired by vibration or the like of a vehicle in which the battery stack 20 is mounted.

Thus, in the battery stack 20, the ambient temperature is detected by the temperature sensor 30, and when the detected ambient temperature falls below a predetermined temperature, the heater control circuit 28 supplies electricity to the heater 24 to heat the spacer 23. Thereby, the spacer 23 expands. As a result, the spacer 23, whose one end is in contact with the vertical wall 22A of the housing 22, presses the other end plate 14A. Since the end plate 14B of the battery stack main body 21 is also in contact with the vertical wall 22B of the housing 22, the distance between the end plates is reduced.

This prevents or suppresses a decrease in the load acting on the battery cells 12 stacked between the end plates 14A and 14B. That is, it is possible to prevent or suppress poor quality of the battery cell 12 due to a decrease in the ambient temperature.

### Third Exemplary Embodiment

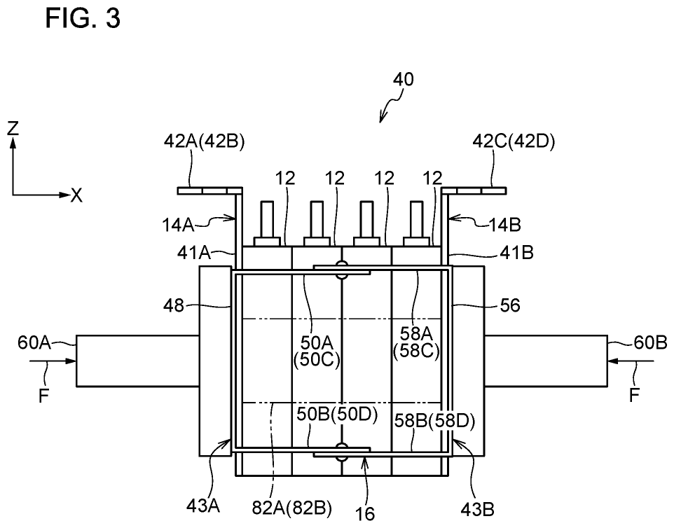

The battery stack according to the third embodiment will be described with reference to FIGS. 3 to 5. Configuration elements that are similar to those in the battery stack of the first and second exemplary embodiments are appended with the same reference numerals, and detailed explanation thereof is omitted.

### (Configuration)

In the present embodiment, a manufacturing method will also be described. First, the specific shape of each component will be described, then a method of manufacturing the battery stack will be described, and then the structure of the manufactured battery stack will be described.

The battery stack main body 40 has substantially the same configuration as the battery stack main body 21 of the second embodiment, but since the shapes of the components are different, the specific shapes will be described.

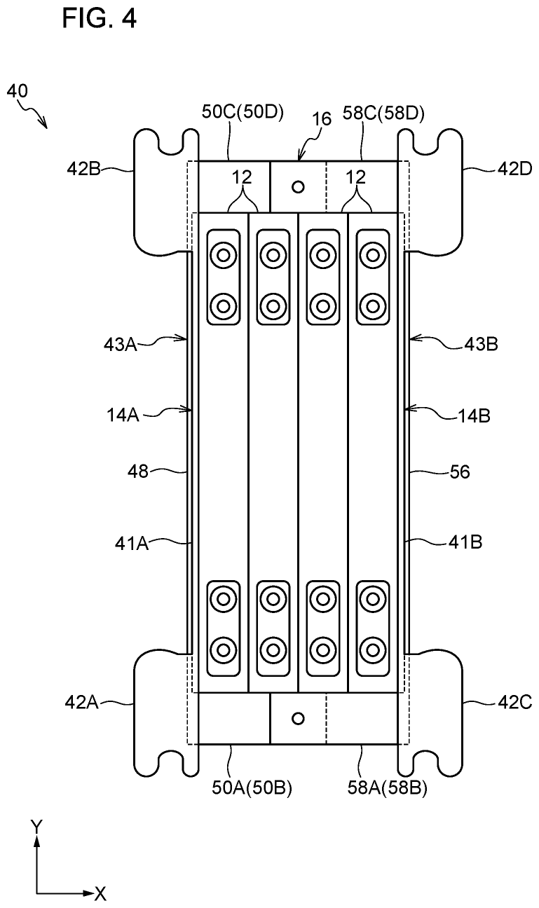

The pair of end plates 14A and 14B constituting the battery stack main body 40 have flat plate portions 41A and 41B extending in the longitudinal direction (arrow Y direction) as shown in FIGS. 3 and 4. In each of the end plates 14A and 14B, horizontal plate portions 42A to 42D are formed at the upper ends of both longitudinal ends of the flat plate portions 41A and 41B, respectively, the horizontal plate portions 42A to 42D protruding towards a short direction outer side and a longitudinal direction outer side. The short direction is the direction of arrow X in the drawings, and the long direction is the direction of arrow Y in the drawings.

The restraint band 16 constituting the battery stack main body 40 is configured by connecting restraining members 43A and 43B by caulk-fastening.

As shown in FIG. 3, each of the restraining members 43A and 43B has a substantial C-shape and a substantial reversed C-shape when viewed in the longitudinal direction.

As shown in FIGS. 3 and 4, the restraining member 43A has a rectangular flat plate portion 48 extending in the height direction of the battery cell 12, that is, the arrow Z direction, and in the longitudinal direction, and has legs 50A to 50D extending from both ends in the height direction at both ends in the longitudinal direction of the flat plate portion 48, to the inside in the short direction, that is, toward the battery cell 12 side.

Further, the restraining member 43B also has a flat plate portion 56 and leg portions 58A to 58D, similarly to the restraining member 43A.

Next, a method for manufacturing the battery stack main body 40 will be described.

As shown in FIG. 3, first, the flat plate portion 48 of the restraining member 43A is fastened to the end plate 14A, and the end plate 14A and the restraining member 43A are integrated. Similarly, the end plate 14B and the restraining member 43B are also integrated.

The battery cells 12 are stacked, and the end plates 14A and 14B to which the restraining members 43A and 43B are fastened are brought into contact with either end of the stacked battery cells 12, respectively.

As a result, as shown in FIGS. 3 and 4, the legs 50A to 50D of the restraining member 43A and the legs 58A to 58D of the restraining member 43B are located on respective longitudinal direction sides of the battery cell 12. Also, as shown in FIGS. 3 and 4, the ends of the legs 50A to 50D and the ends of the legs 58A to 58D overlap.

In this state, as shown in FIG. 3, pressure is applied from outer sides of the end plates 14A and 14B (the sides opposite to the battery cells 12) to the battery cells 12 by the restraining jigs 60A and 60B so that a predetermined load F is applied. Specifically, the flat plates 48, 56 of the restraining members 43A, 43B fastened to the end plates 14A, 14B are pressed by the restraining jigs 60A, 60B.

In this state, caulking is performed at a portion where the ends of the legs 50A to 50D of the restraining member 43A and the ends of the legs 58A to 58D of the restraining member 43B overlap.

Thereafter, pressurization of the battery stack main body 40 by the restraining jigs 60A and 60B is stopped. That is, the restraining jigs 60A and 60B are separated from the restraining members 43A and 43B.

Thus, the end plates 14A and 14B are restrained by the restraint bands 16 (the restraining members 43A and 43B), and the battery stack main body 40, in which a predetermined load is applied to the battery cells 12, is manufactured.

Next, a battery stack 80 using the battery stack main body 40 will be described.

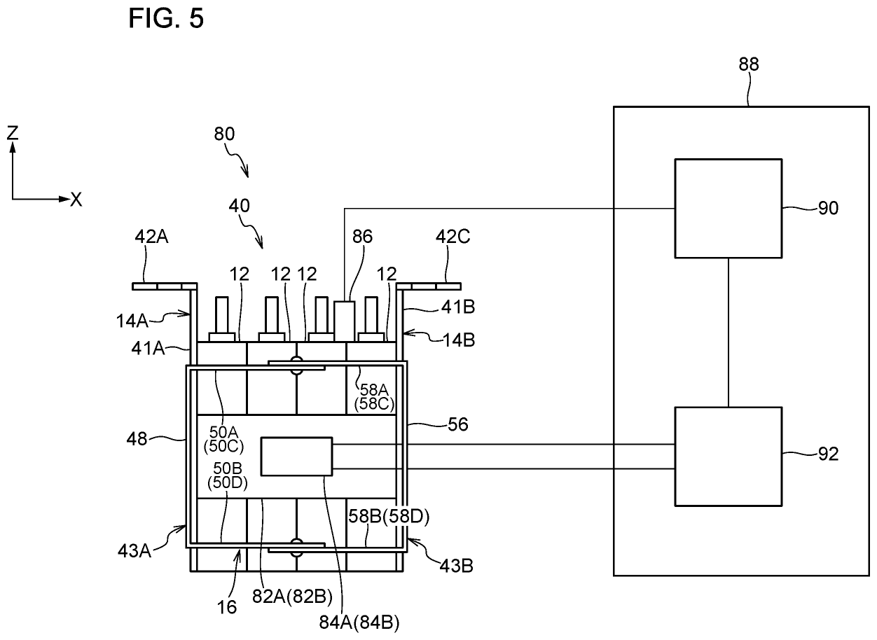

As shown in FIG. 5, in the battery stack 80, spacers 82A and 82B are press-fitted between the pair of end plates 14A and 14B on respective longitudinal sides of the battery cells 12 constituting the battery stack main body 40. The spacers 82A and 82B are arranged in parallel with the legs 50A to 50D and 58A to 58D of the restraining members 43A and 43B.

In addition, respective short direction ends of the spacers 18A and 18B are in contact with the end plates 14A and 14B.

The spacers 82A and 82B are respectively provided with heaters 84A and 84B on the surface opposite to the battery cell 12. The spacers 82A and 82B and the heaters 84A and 84B correspond to a “load change suppressing member.”

Further, one of the battery cells 12 is provided with a thermistor 86 for detecting the temperature of the battery cell 12.

Further, as shown in FIG. 5, the battery stack 80 includes a control unit 88. The control unit 88 has a battery temperature monitoring circuit 90 that detects the temperature of the battery cell 12 based on the output signal of the thermistor 86, and outputs a drive signal to a heater control circuit 92 described below when the detected temperature of the battery cell 12 becomes equal to or higher than a predetermined temperature, and a heater control circuit 92 that supplies current to the heaters 84A and 84B when a drive signal is input from the battery temperature monitoring circuit 90. Note that the thermistor 86 and the battery temperature monitoring circuit 90 correspond to a “temperature detecting section.” Note that the heater control circuit 92 corresponds to a “heater control unit.”

### (Action)

In the battery stack main body 40 of the battery stack 80, a predetermined load is applied to each battery cell 12 by restraining the end plates 14A and 14B by the restraint band 16. However, in the battery stack 80, when each battery cell 12 expands due to a rise in the temperature of the battery cell 12, the load, acting on the battery cells 12 stacked between the end plates 14A and 14B restrained by the restraint band 16, increases. Here, when the load acting on each battery cell 12 exceeds a predetermined load, the quality the battery cell 12 becomes poor.

When the battery temperature monitoring circuit 90 detects that the temperature of the battery cell 12 is equal to or higher than the predetermined temperature based on the output signal of the thermistor 86, the control unit 88 of the battery stack 80 outputs the drive signal to the heater control circuit 92. As a result, the heater control circuit 92 energizes the heaters 84A and 84B. As a result, the spacers 82A and 82B are heated, and the spacer 82 expands (extends) between the end plates 14A and 14B.

Due to the extension of the spacer 82, the distance between the end plates 14A and 14B is expanded in resistance to the restraining force of the restraint band 16. As a result, an increase in the load acting on the battery cell 12 due to an increase in the temperature of the battery cell 12 can be prevented or suppressed. Therefore, it is possible to prevent or suppress defective quality of the battery stack 80 and the battery cells 12 due to temperature rise of the battery cells 12.

In the method of manufacturing the battery stack 80 and the battery stack main body 40 of the present embodiment, the flat plates 48, 56 of the restraining members 43A, 43B fastened to the end plates 14A, 14B are subjected to pressing by a predetermined load F by the restraining jigs 60A, 60B, and in this state, after the overlapped portions of the legs 50A to 50D of the restraining member 43A and the legs 58A to 58D of the restraining member 43B are caulked, the pressurization from the restraining jigs 60A and 60B is stopped.

By manufacturing as described above, the battery stack main body 40 in which a predetermined load is applied to the battery cell 12 by the restraint band 16 can be easily manufactured.

Further, the spacers 82A and 82B are press-fitted between the end plates 14A and 14B of the battery stack main body 40, so that the spacers 82A and 82B can be arranged between the end plates 14A and 14B in a state where respective ends thereof are in contact with the end plates 14A and 14B.

That is, the battery stack 80 can be easily manufactured.

### Fourth Exemplary Embodiment

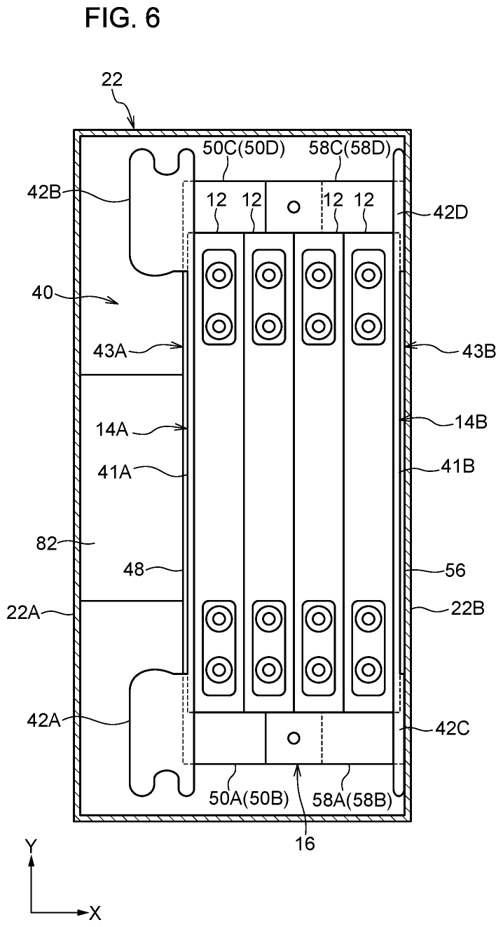

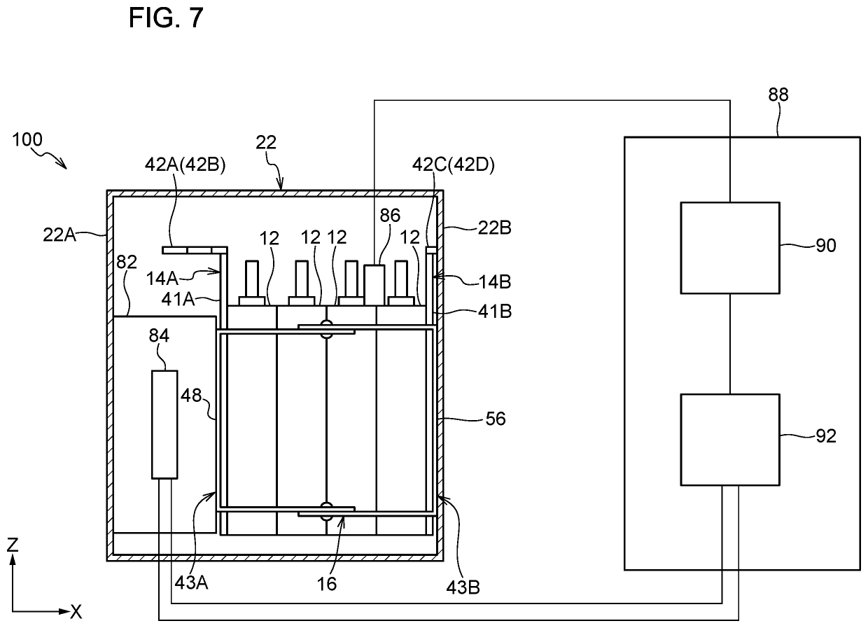

The battery stack according to the fourth embodiment will be described with reference to FIGS. 6 and 7. Configuration elements that are similar to those in the battery stack of the second and third exemplary embodiments are appended with the same reference numerals, and detailed explanation thereof is omitted.

### (Configuration)

Since the configuration and the manufacturing method of the battery stack main body 40 are the same as those of the third embodiment, description thereof will be omitted with reference to FIGS. 3 and 4.

The battery stack main body 40 configuring the battery stack 100 is disposed inside the housing 22 as shown in FIGS. 6 and 7. A spacer 82 is press-fitted between the flat plate portion 48 of the restraining member 43A fastened to one end plate 14A and the vertical wall 22A of the housing 22. In the other restraining member 43B fastened to the other end plate 14B, the flat plate portion 56 is in contact with the other vertical wall 22B of the housing 22.

As shown in FIG. 7, the spacer 82 is provided with a heater 84. The spacer 82 and the heater 84 correspond to a “load change suppressing member.”

Further, one of the battery cells 12 is provided with a thermistor 86 for detecting the temperature of the battery cell 12.

Further, as shown in FIG. 7, the battery stack 100 includes a control unit 88. The control unit 88 has a battery temperature monitoring circuit 90 that detects the temperature of the battery cell 12 based on the output signal of the thermistor 86, and outputs a drive signal to a heater control circuit 92 described below when the detected temperature of the battery cell 12 becomes equal to or lower than a predetermined temperature, and a heater control circuit 92 that supplies current to the heater 84 when a drive signal is input from the battery temperature monitoring circuit 90. Note that the thermistor 86 and the battery temperature monitoring circuit 90 correspond to a “temperature detecting section.” Note that the heater control circuit 92 corresponds to a “heater control unit.”

### (Action)

In the battery stack 100, each battery cell 12 is reduced in size by a decrease in the temperature of the battery cell 12. Thereby, the load acting on each battery cell 12, to which a predetermined load has been applied by the restriction of the end plates 14A, 14B by the restraining members 43A, 43B, is reduced. Here, if the load acting on each battery cell 12 falls below a predetermined load, the quality of the battery cell 12 is impaired by vibration of a vehicle in which the battery stack 100 is mounted, for example.

In the battery stack 100, the control unit 88 detects the temperature of the battery cell 12 based on the output signal of the thermistor 86, and when the temperature of the battery cell 12 falls to a predetermined temperature or below, the battery temperature monitoring circuit 90 outputs a drive signal to the heater control circuit 92. As a result, the heater control circuit 92 energizes the heater 84 and heats the spacer 82. As a result, the spacer 82, whose one end is in contact with the vertical wall 22A of the housing 22, presses the restraining member 43A at the other end. Thereby, the end plate 14A to which the restraining member 43A is fastened is pressed toward the end plate 14B. The other end plate 14B is in contact with the other vertical wall 22B via the restraining member 43B.

As a result, the distance between the pair of end plates 14A, 14B is reduced in resistance to the restraint band 16.

This prevents or suppresses a decrease in the load acting on the battery cells 12 stacked between the end plates 14A and 14B. That is, it is possible to prevent or suppress defective quality of the battery cells 12 due to a decrease in the temperature of the battery cells 12.

When the restraining members 43A and 43B are fastened (abutted) to the end plates 14A and 14B as in the present embodiment, even when the restraining member 43A abuts the spacer 82, the end plate 14A is included in the configuration abutting the spacer 82. Further, a case in which the restraining member 43B abuts the vertical wall 22B of the housing 22 is also included in a case in which the end plate 14B abuts the vertical wall 22B.

### Other Example 1

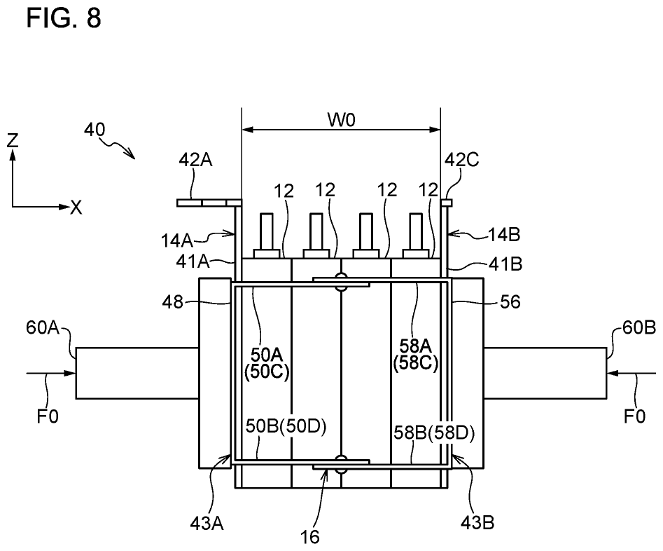

A battery stack 110 according to another example 1 of the fourth embodiment will be described with reference to FIGS. 8 to 11A and 11B. Configuration elements that are similar to those in the battery stack of the first to fourth exemplary embodiments are appended with the same reference numerals, and detailed explanation thereof is omitted.

### (Configuration)

The configuration of the battery stack 110 will be described together with its manufacturing method.

First, a method for manufacturing the battery stack main body 40 will be described. As shown in FIG. 8, the restraining jigs 60A and 60B press the flat plates 48 and 56 of the restraining members 43A and 43B fastened to the end plates 14A and 14B with a predetermined load F0. In this state, the overlapping portions of the legs 50A to 50D and the legs 58A to 58D of the restraining members 43A and 43B are caulked. Thus, the end plates 14A and 14B are restrained by the restraint band 16.

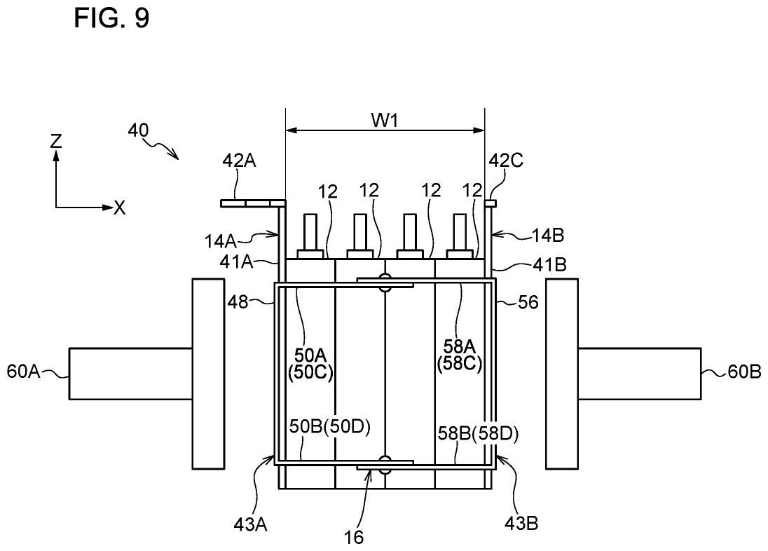

Next, as shown in FIG. 9, the restraining jigs 60A and 60B are separated from the restraining members 43A and 43B of the battery stack main body 40. Thereby, the load acting on the battery stack main body 40 is reduced, and the distance between the end plates becomes W1.

When the spring constant of the battery stack main body 40 (the stacked battery cells 12) is k, and the load acting on the battery cells 12 is F1 after the battery stack main body 40 is released from the restraining jigs 60A and 60B (the restraining jigs 60A and 60B are separated from the battery stack main body 40), then

F1−F0=−k(W1−W0) (1)

Therefore, the load F1 becomes

F1=F0−k(W1−W0) (2)

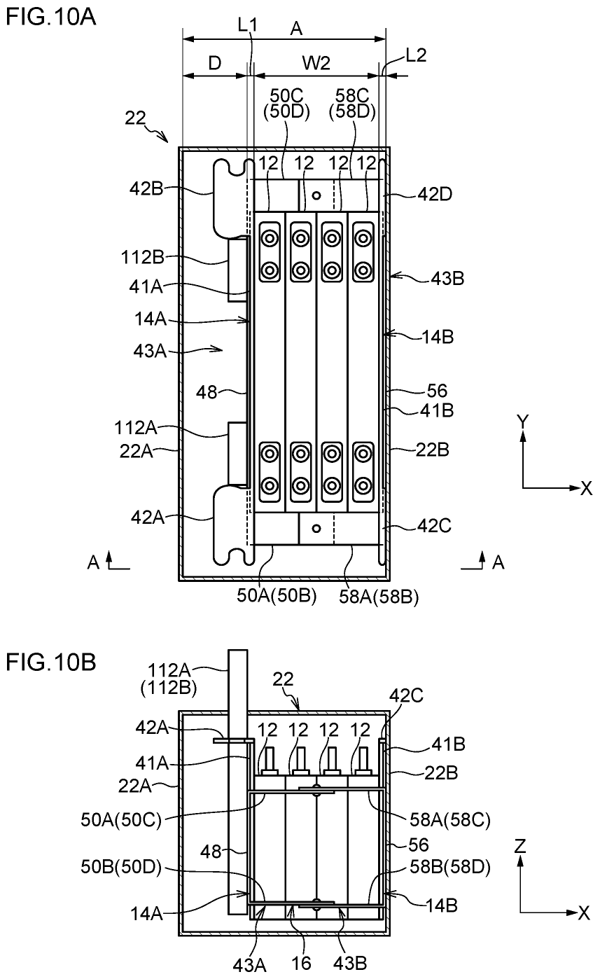

Subsequently, as shown in FIGS. 10A and 10B, the battery stack main body 40 is disposed inside the housing 22. The restraining member 43B of the battery stack main body 40 are arranged so as to be in contact with the vertical wall 22B of the housing 22.

Here, when the load F1 acting on the battery cells 12 of the released battery stack main body 40 is smaller than the target load FX, the restraint band 16 of the battery stack main body 40 is pressed by the re-restraining jigs 112A and 112B, so that the distance between the end plates is adjusted to be W2. The housing 22 is formed with service holes into which the re-restraint jigs 112A and 112B can be inserted.

That is,

$$\begin{matrix}FX - F 1 = - k ( W 2 - W 1 ) & ( 3 ) \\ \begin{matrix}FX = F 1 - k ( W 2 - W 1 ) \\ = F 0 - k ( W 1 - W 0 ) - k ( W 2 - W 1 ) \\ = F 0 - k ( W 2 - W 0 )\end{matrix} & ( 4 )\end{matrix}$$

Therefore, the distance W2 between the end plates under a predetermined load is expressed by the following equation.

W2=(−1/k)×(FX−F0)+W0 (5)

In order that the distance W2 between the end plates calculated by the equation (5) is obtained, the re-restraining jigs 112A and 112B press the flat plate portion 48 of the restraining member 43A on the end plate 14A side against the battery stack main body 40 in a state in which the flat plate portion 56 of the restraining member 43B on the end plate 14B side in the housing 22 is in contact with the vertical wall 22B of the housing 22.

Note that when the distance between the end plates of the battery stack main body 40 is W2 inside the housing 22, the thickness D of the spacer inserted between the vertical wall 22A of the housing 22 and the restraining members 43A and 43B is found by the following expression, where L1 is the length in the short direction of the flat plate portion 48 of the restraining member 43A and the flat plate portion 41A of the end plate 14A, L2 is the length in the short direction of the flat plate portion 56 of the restraining member 43B and the flat plate portion 41B of the end plate 14B, and A is the length in the short direction between the vertical walls 22A and 22B of the housing 22.

D=A−(L1+L2+W2) (6)

Therefore, the target load FX can be set so as to act on the battery cell 12 by press-fitting the spacer 82, having thickness D, between the restraining member 43A of the battery stack main body 40 and the vertical wall 22A of the housing 22.

The spacer 82 may be prepared in advance with several thicknesses, and a spacer having a thickness closest to D may be inserted.

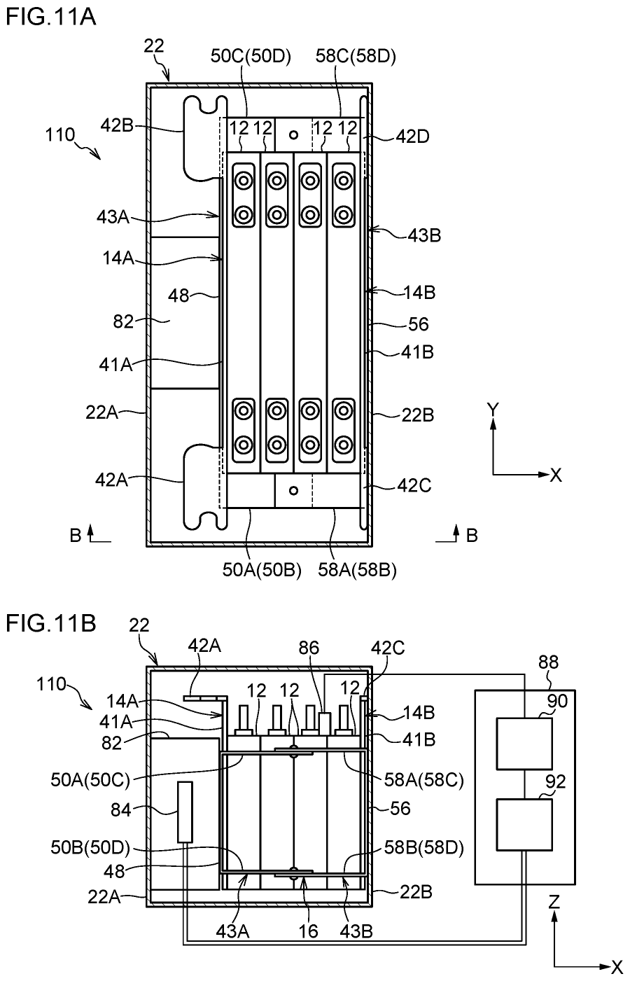

In addition, in the battery stack 110 configured as described above, as shown in FIG. 11B, a heater 84 is provided at the spacer 82 and a thermistor 86 is provided at the battery cell 12. The heater 84 and the thermistor 86 are connected to the control unit 88 to have the same configuration as in the battery stack 100.

### (Action)

As described above, in the battery stack 110, when manufacturing and assembling the battery stack main body 40, the end plates 14A and 14B are pressurized with the predetermined load F0 via the restraining members 43A and 43B of the battery stack main body 40 by the restraining jigs 60A and 60B, and after the end plates 14A, 14B are constrained by the restraint band 16 by caulking the restraining members 43A, 43B in this state, the constraining jigs 60A, 60B are separated from the restraining members 43A, 43B.

At this time, due to variations in manufacturing accuracy and material characteristics (for example, Young's modulus) of each component constituting the battery stack main body 40, when the restraining jigs 60A and 60B are separated from the restraining members 43A and 43B, the load acting on the battery cells 12 varies.

However, when the load acting on the battery cell 12 is F1, that is, when the distance W1 between the end plates is less than a predetermined value, it is possible to make an adjustment by pressing the battery stack main body 40 again with the re-restraining jigs 112A and 112B, and by inserting a spacer 82 having a predetermined thickness D between the vertical wall 22A of the housing 22 and the flat plate portion 48 of the restraining member 43A, such that the target load FX acts on the battery cells 12 of the battery stack main body 40.

Therefore, in the battery stack 110, variation in the load acting on each battery cell 12 for each product can be suppressed, and the life of the battery stack main body 40 can be extended.

### Other Example 2

A battery stack 120 according to another example 2 of the fourth embodiment will be described. Configuration elements that are similar to those in the battery stacks of the first to fourth exemplary embodiments are appended with the same reference numerals, and detailed explanation thereof is omitted.

### (Configuration)

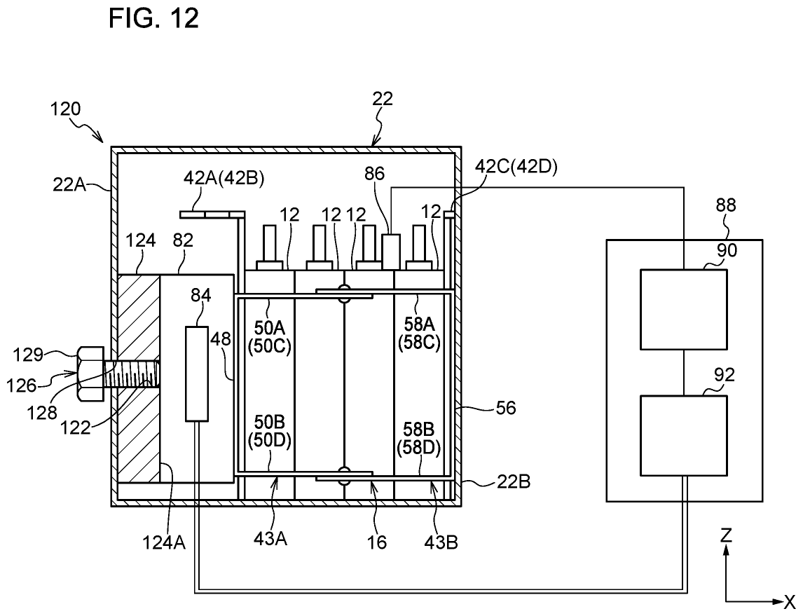

As shown in FIG. 12, the battery stack 120 has a rectangular adjusting portion 124 in which a screw hole 122 is formed, which is fixed to the vertical wall 22A of the housing 22. A screw 126 is screwed into the screw hole 122 of the adjusting portion 124 via an insertion hole 128 formed in the vertical wall 22A. The head 129 of the screw 126 is located outside the vertical wall 22A of the housing 22. The screw 126 reaches the innermost part of the screw hole 122 but does not protrude outside it. The adjustment unit 124 corresponds to a “wall.”

The spacer 82 is press-fitted between the end surface 124A of the adjusting portion 124 and the restraining member 43A of the battery stack main body 40.

### (Action)

Creep is generated in the restraint band 16 and the like constituting the battery stack main body 40, whereby the restraint band 16 restrains the end plates 14A and 14B, thereby reducing the load acting on the battery cells 12.

Therefore, after a lapse of a predetermined time from the start of use of the product, the head 129 of the screw 126 is operated to cause the tip of the screw 126 to protrude from the end surface 124A of the adjustment unit 124. Thus, the screw 126 presses the spacer 82 toward the battery cells 12 and the restraining member 43A. As a result, the distance between the end plates of the battery stack main body 40 is shortened, and any decrease in the load acting on the battery cells 12 due to creep of the restraint band 16 or the like is suppressed. That is, the life of the battery stack 120 and the battery stack main body 40 can be extended.

### [Other Matters]

The number of battery cells 12 stacked between the end plates 14A and 14B of the battery stack main body in each embodiment is not particularly limited.

In the battery stack, the heater is energized based on the ambient temperature of the battery cell or the temperature of the battery cell. However, the detection of the battery cell ambient temperature and the detection of the battery cell temperature may be substituted.

Further, in the third and fourth embodiments, the restraining jigs 60A and 60B are configured to press the restraining members 43A and 43B at the time of manufacturing the battery stack. However, the present invention is not limited to this. The restraining jigs 60A and 60B may directly press the end plates 14A and 14B. Similarly, the re-restraining jigs 112A and 112B may directly press the end plate 14A.

In the third embodiment, the spacers 82A and 82B are press-fitted between the end plates 14A and 14B after the manufacture of the battery stack main body 40. However, the restraining members 43A and 43B may be caulked after the spacers 82A and 82B are arranged between the end plates 14A and 14B. See FIG. 3, where spacers 82A and 82B are shown with double-dot dashed lines. In this case, it is not necessary to press-fit the spacers 82A, 82B between the end plates 14A, 14B when the battery stack 80 is manufactured, and the arrangement of the spacers 82A, 82B is made easier.

Although exemplary embodiments have been described above, the present disclosure can of course, can be implemented in various forms within a scope that does not depart from the gist thereof.

What is claimed is:

1. A battery stack, comprising:
a plurality of substantially rectangular body-shaped battery cells;
a pair of end plates disposed at respective end parts, in a stacking direction, of the plurality of battery cells, which are stacked in a short direction of the battery cells;
a restraint band configured to restrain the pair of end plates, and to apply a stacking direction load to the battery cells, which are stacked between the pair of end plates; and
a load change suppression member configured to suppress change in the stacking direction load acting on the battery cells by pressing the pair of end plates in a case in which an ambient temperature of the battery cells or a cell temperature of the battery cells has changed.

2. The battery stack of claim 1, wherein the load change suppression member comprises a spacer that is disposed between the pair of end plates such that respective end parts of the spacer abut on the respective end plates, and that has a larger coefficient of linear expansion than the restraint band.

3. The battery stack of claim 1, wherein the load change suppression member comprises:
a spacer that is disposed between the pair of end plates such that respective end parts of the spacer abut on the respective end plates; and
a heater configured to heat the spacer.

4. The battery stack of claim 3, further comprising:
a temperature detection unit configured to detect the cell temperature of the battery cells or the ambient temperature of the battery cells; and
a heater control unit configured to drive the heater in a case in which the cell temperature or the ambient temperature detected by the temperature detection unit is equal to or higher than a predetermined temperature.

5. The battery stack of claim 1, wherein the load change suppression member comprises:
a spacer that is disposed between one of the pair of end plates and one wall part such that respective end parts of the spacer abut on the one of the pair of end plates and the one wall part; and
a heater configured to heat the spacer,
wherein another of the pair of end plates abuts on another wall part.

6. The battery stack of claim 5, further comprising:
a temperature detection unit configured to detect the cell temperature of the battery cells or the ambient temperature of the battery cells; and
a heater control unit configured to drive the heater in a case in which the cell temperature or the ambient temperature detected by the temperature detection unit is equal to or lower than a predetermined temperature.

7. The battery stack of claim 5, wherein the one wall part comprises an adjustment unit including a screw hole that is open toward the one of the pair of end plates, and a threading amount of a screw threaded into the screw hole is adjustable.

8. A method of manufacturing a battery stack, the method comprising:
applying a predetermined stacking direction load to respective battery cells by attaching a pair of end plates to respective end parts, in a stacking direction, of a stacked plurality of the battery cells, and by restraining the pair of end plates with a restraint band in a state in which the predetermined stacking direction load is applied between the pair of end plates; and
press-fitting a spacer between the pair of end plates such that respective end parts of the spacer abut on the respective end plates.

9. A method of manufacturing a battery stack, the method comprising:
attaching end plates to respective end parts, in a stacking direction, of a stacked plurality of battery cells, and disposing a spacer between a pair of the end plates such that respective end parts of the spacer abut on the respective end plates; and
restraining the pair of end plates with a restraint band in a state in which a predetermined stacking direction load is applied to each of the battery cells stacked between the pair of end plates.

10. A method of manufacturing a battery stack, the method comprising:
manufacturing a battery stack main body wherein a predetermined stacking direction load is applied to respective battery cells, by disposing a pair of end plates at respective end parts, in a stacking direction, of a stacked plurality of the battery cells, and by restraining the pair of end plates with a restraint band in a state in which the predetermined stacking direction load is applied between the pair of end plates by a restraining jig;
releasing the predetermined stacking direction load that was being applied between the pair of end plates by the restraining jig;
disposing the battery stack main body inside a housing such that one of the pair of end plates abuts on one wall part of the housing; and
in a case in which a distance between the pair of end plates exceeds a predetermined distance, inserting a spacer so as to abut on another of the pair of end plates and another wall part of the housing in a state in which the distance between the pair of end plates has been adjusted by reduction by pressing the other of the pair of end plates with a re-restraining jig.
